(19) United States
(12) Patent Application Publication
(10) Pub. No.: US 2007/0060724 A1
(43) Pub. Date: Mar. 15, 2007

(54) Enhanced catalyst productivity

(75) Inventors: Victoria Ker, Calgary (CA); Shivendra Kumar Goyal, Calgary (CA); Mark Kelly, Airdrie (CA); Yan Jiang, Calgary (CA); Claudine Viviane Lalanne-Magne, Saint Mitre les Remparts (FR)

Correspondence Address: KENNETH H. JOHNSON, P.O. BOX 630708, HOUSTON, TX, 77263, US

(73) Assignee: NOVA Chemicals Corporation and Innovene Europe Ltd.

(21) Appl. No.: 11/225,612

(22) Filed: Sep. 13, 2005

(51) Int. Cl. C08F 2/00

(52) U.S. Cl. 526/74; 526/901; 526/124.3; 526/160; 526/106

(57) ABSTRACT

The productivity of a catalyst in a gas phase polymerization of olefins (e.g. grams of polymer per gram of catalyst) may be increased by including in the gas phase from 1 to 20 weight % of an inert non-polymerizable hydrocarbon. The hydrocarbon may be in gaseous form but preferably is in liquid form.

### FIELD OF THE INVENTION

The present invention relates to gas phase polymerization of olefin monomers. More particularly the present invention relates to a method to improve reactor operability (specifically fines, particle morphology, particle agglomerations, reactor fouling and sheet formation) in a gas phase polymerization and to increase the productivity of the catalyst (e.g. grams of polymer produced per gram of catalyst) without significantly increasing (typically less than 5%) the space time yield (STY, i.e. production rate per fluidized reactor bed volume (kg/hr/m³)). The present invention is particularly useful in conjunction with the production of olefin polymers having a density greater than about 0.940 g/cc.

### BACKGROUND OF THE INVENTION

There are a number of patents which disclose increasing the space time yield (STY) of a gas phase polymerization by including in the recycle stream a hydrocarbon which is in the liquid phase when the recycle stream enters the reactor and vaporizes as the hydrocarbon passes through a fluidized bed. The technology is sometimes referred to as condensed mode (U.S. Pat. Nos. 4,543,399 and 4,588,790 in the name of Jenkins III et al. issued Sep. 24, 1985 and May 13, 1986 respectively, assigned to Union Carbide) and super condensing mode (U.S. Pat. Nos. 5,462,999 and 5,436,304 issued Oct. 31, 1995 and Jul. 25, 1999 respectively, in the name of Griffin et al.; and U.S. Pat. Nos. 5,352,749 and 5,405,922 issued Oct. 4, 1994 and Apr. 11, 1995 respectively in the name of DeChellis et al., assigned to Exxon Chemical Patents, Inc.). As the space time yield of the process increases (more pounds of polymer per fluidized bed volume) the residence time of the growing polymer in the fluidized bed containing the catalyst decreases. As a result, the productivity of the catalyst (grams of polymer produced per gram of catalyst) is lowered. While the patents teach the presence of a condensable non-polymerizable hydrocarbon component in the gas phase, the patents teach away from the present invention because the productivity of the catalyst decreases.

The article “Polymerization of Olefins through Heterogeneous Catalysis. VIII. Monomer Sorption Effects” by R. A. Hutchinson and W. H., Ray Journal of Applied Polymer Science, Vol. 41, 51-81 (1990), at page 75 speculates that a higher polymerization rate should be seen in a gas polymerization if an inert hydrocarbon (e.g. butane or hexane) is used to swell the polymer. The paper gives no experimental data. The paper provides no distinction between the impact on low and high-density resins and no indication if the hydrocarbon is present in a liquid or gaseous form.

U.S. Pat. No. 5,969,061 issued Oct. 19, 1999 to Wonders et al., assigned to Eastman Chemical Company teaches a method to reduce polymer fines in the gas polymerization of low density polyolefins by adjusting the amount of inert C₃₋₈ hydrocarbons in the gas phase. The patent teaches the technology is applicable to low density polyolefins having a density of about 0.920 g/cc. However, this teaches away from the lower density limit of 0.940 g/cc described in the current invention.

The present invention seeks to provide a method to improve the reactor operability of a gas phase polymerization of olefin monomers to form a polymer having a density greater than 0.940 g/cc without increasing the space time yield (STY) by more than 5%. In a preferred embodiment, the present invention provides a process to increase the productivity of a catalyst in a gas phase polymerization of olefin monomers to produce a polyolefin having a density greater than 0.940 g/cc without increasing the space time yield (STY) by more than 5% preferably less than 2.5%, most preferably less than 1%, desirably less than 0.5%.

### SUMMARY OF THE INVENTION

The present invention provides a method to improve the reactor operability (specifically fines, particle morphology, particle agglomerations, and sheet formation) in a gas phase polymerization process wherein the resulting polymer has a density greater than 0.940 g/cc without increasing the space time yield (STY) by more than 5% comprising conducting the polymerization in the presence of a non-polymerizable hydrocarbon.

In another embodiment, the present invention provides a method to improve the productivity of a catalyst in a gas phase polymerization process wherein the resulting polymer has a density greater than 0.940 g/cc without increasing the space time yield (STY) by more than 5% comprising conducting the polymerization in the presence of a non-polymerizable hydrocarbon.

### BRIEF DESCRIPTION OF THE DRAWINGS

FIG. 1 is a graph showing the effect of increasing the amount of hexane in the reactor on the productivity of a Ziegler-Natta type catalyst in a bench scale reactor (BSR) homopolymerization of high density polyethylene (HDPE).

FIG. 2 is a plot of the effect of iso-pentane on the productivity of two different Ziegler-Natta catalysts in a technical scale reactor (TSR) gas phase polymerization of HDPE.

FIG. 3 shows the effect of increasing the level of iso-pentane as well as the form of the iso-pentane delivered on the productivity and fines, in a technical scale reactor (TSR) gas phase polymerization of HDPE in the presence of a Ziegler-Natta catalyst.

FIG. 4 shows the effect of iso-pentane form (liquids versus no liquids) on catalyst productivity in HDPE gas phase polymerizations in the presence of a Ziegler-Natta catalyst, while maintaining a constant amount of iso-pentane in the TSR.

FIG. 5 shows the morphology of HDPE produced on the TSR in the presence of a Ziegler-Natta catalyst without iso-pentane.

FIG. 6 shows the morphology of HDPE produced on the TSR in the presence of a Ziegler-Natta catalyst with 3 weight % iso-pentane in the feed stream.

FIG. 7 shows the effect of adding pentane to a pilot plant reactor on catalyst productivity when preparing HDPE in the presence of a Ziegler Natta catalyst.

### DETAILED DESCRIPTION

The present invention relates to the preparation of a polyolefin typically comprising from 100 to 94 weight % of ethylene and from 0 to 6, preferably less than 5 weight % of one or more comonomers selected from the group consisting of C₃₋₈ alpha olefins. Some comonomers include propene, butene, hexene and octene, preferably butene and hexene. The resulting polymers will have a density of at least 0.940 g/cc, preferably at least 0.945 g/cc, generally from 0.940 to 0.968 g/cc, typically from about 0.945 to 0.960 g/cc.

The polymers may be prepared using a gas phase polymerization process. The gas phase process may be a stirred bed or fluidized bed process. Such processes are well known in the art. Fluidized bed polymerization processes are discussed in a number of patents including the above noted U.S. Patents to Union Carbide and Exxon Chemical Patents, Inc. Generally, in the gas phase polymerization process for HDPE, the temperature of the reactor will be from 85 to 120° C., typically from 85 to 115° C., preferably from 90 to 115° C. The reactor pressure (e.g. total pressure in the reactor) will be from 100 to 500 psi (689 to 3,445 kPa), typically from 150 to 300 psi (1,033 to 2,067 kPa), preferably from 200 to 300 psi (1,378 to 2,067 kPa).

Generally the feed stream will comprise the appropriate monomers, hydrogen, an inert gas such as nitrogen etc., as is typically known in the art. In addition, the feed will comprise from about 1 to about 20, typically from about 2 to 15, preferably from about 2 to 10 weight % of a non copolymerizable hydrocarbon (based on the recycle stream). Generally the hydrocarbon will be a C₃₋₈, preferably C₄₋₈, most preferably C₄₋₆ straight chain, branched, or cyclic saturated hydrocarbon. Some saturated hydrocarbons include propane, butane, pentane, iso-pentane, hexane, iso-hexane and cyclohexane. It is believed part of the non-copolymerizable hydrocarbon will be adsorbed onto the growing polymer particles in the reactor and possibly swell the polymer particles.

The catalyst for the polymerization may comprise a Phillips type chromium (Cr) catalyst, a Ziegler-Natta catalyst or a bulky ligand single site catalyst and conventional activators/co-catalysts. Ziegler-Natta catalysts have been reviewed in the literature by a number of authors. In particular, reviews by Pullukat, T. J. and Hoff, R. E in Catal. Rev. Sci. Eng., 41(3&4), 389-428, 1999 and Xie, T.; McAuley, K. B.; Hsu, J. C. C. and Bacon, D. W. in Ind. Eng. Chem. Res., 33, 449-479, 1994 and references within give a good understanding what is meant by a Ziegler-Natta catalyst. Other authors have described single site catalysts. In particular, reviews by Mülhaupt, R. Macromol. Chem. Phys. 2004, 289-327, 2003 and Boussie, T. R. et al. in J. Am Chem. Soc., 125, 4306-4317, 2003 and references within give a good understanding by what is meant by single site catalysts.

The chromium based catalysts are typically chromium oxide on a support as described below. The catalysts are typically prepared by contacting the support with a solution comprising an inorganic (e.g. Cr(NO₃)₃ or an organic (e.g. chromium acetate, silyl chromate—e.g. a bis hydrocarbyl silyl chromate) chromium compound. The bis hydrocarbyl component may be a trialkyl compound (e.g. trimethyl) or a tri aryl compound (e.g. tribenzyl). The inorganic chromium catalysts and chromium acetate type catalysts are air oxidized at elevated temperature (e.g. 400 to 800° C.) to activate them. The silyl chromium compounds are activated with an aluminum compound. If the support does not contain aluminum or titanium the catalyst may be activated with aluminum compounds described below for the Ziegler Natta catalysts (e.g. tri alkyl aluminums and dialkyl aluminum halides preferably chlorides. The chromium catalyst may also be a chromocene catalyst as described for example in U.S. Pat. No. 3,879,368 issued Apr. 22, 1975 to Johnson, assigned to Union carbide Corporation.

Typically, the Ziegler-Natta catalysts comprise a support, a magnesium compound (optionally in the presence of a halide donor to precipitate magnesium halide), a titanium compound and an aluminum compound, in the presence of an electron donor. The aluminum compound may be added at several stages. It may be added to the support to chemically treat it and/or it may be added at some later point during the manufacture of the catalyst.

The support for the catalysts useful in the present invention typically comprises an inorganic substrate usually of alumina or silica having a pendant reactive moiety. The reactive moiety may be a siloxyl radical or more typically is a hydroxyl radical. The preferred support is silica. The support should have an average particle size from about 10 to 150 microns, preferably from about 20 to 100 microns. The support should have a large surface area typically greater than about 100 m²/g, preferably greater than about 250 m²/g, most preferably from 300 m²/g to 1,000 m²/g. The support will be porous and will have a pore volume from about 0.3 to 5.0 ml/g, typically from 0.5 to 3.0 ml/g.

The support can be heat treated and/or chemically treated to reduce the level of surface hydroxyl (OH) groups in a similar fashion to that described by A. Noshay and F. J. Karol in Transition Metal Catalyzed Polymerizations; Ed. R. Quirk, 1989; pg. 396. After treatment, the support may be put into a mixing vessel and slurried with an inert solvent or diluent preferably a hydrocarbon, and contacted with or without isolation or separation from the solvent or diluent with the catalyst components.

It is important that the support be dried prior to the initial reaction with an aluminum compound. Generally, the support may be heated at a temperature of at least 200° C. for up to 24 hours, typically at a temperature from 500° C. to 800° C. for about 2 to 20, preferably 4 to 10 hours. The resulting support will be free of adsorbed water and should have a surface hydroxyl content from about 0.1 to 5 mmol/g of support, preferably from 0.5 to 3 mmol/g.

A silica suitable for use in the present invention has a high surface area and is amorphous. For example, commercially available silicas are marketed under the trademark of Sylopol® 958 and 955 by the Davison Catalysts a Division of W. R. Grace and Company and ES-70W by Ineos Silica.

The amount of the hydroxyl groups in silica may be determined according to the method disclosed by J. B. Peri and A. L. Hensley, Jr., in J. Phys. Chem., 72 (8), 2926, 1968, the entire contents of which are incorporated herein by reference.

While heating is the most preferred means of removing OH groups inherently present in many carriers, such as silica, the OH groups may also be removed by other removal means, such as chemical means. For example, a desired proportion of OH groups may be reacted with a suitable chemical agent, such as a hydroxyl reactive aluminum compound (e.g. triethyl aluminum) or a silane compound. This method of treatment has been disclosed in the literature and two relevant examples are: U.S. Pat. No. 4,719,193 to Levine in 1988 and by Noshay A. and Karol F. J. in Transition Metal Catalyzed Polymerizations, Ed. R. Quirk, 396, 1989. For example the support may be treated with an aluminum compound of the formula R¹_{b}Al(OR¹)ₐX_{3-(a+b)} wherein a is an interger from 0 to 3, b is an integer from 0 to 3 and the sum of a+b is from 0 to 3, R¹ is the same or different C₁₋₁₀ alkyl radical and X is a chlorine atom. The amount of aluminum compound is such that the amount of aluminum on the support prior to adding the remaining catalyst components may be from about 0.5 to 2.5 weight %, preferably from 1.0 to 2.0 weight % based on the weight of the support. The remaining aluminum content is added as a subsequent or second component of the catalyst (e.g. Al²).

The support could be a polymeric support typically polystyrene which may be crosslinked with a crosslinking agent such as divinyl benzene. The amount of crosslinking agent may range from about 5 to 50, typically less than 30 weight % of the polystyrene. The polymeric support may contain functional groups such as ester groups exemplified by lower C₄₋₆ hydroxyalkyl esters of C₃₋₆ ethylenically unsaturated carboxylic acids (e.g. acrylic acid, methacrylic acid). For example the esters could be hydroxyethyl acrylate or hydroxyethyl methacrylate (HEMA).

Typically the Ziegler-Natta catalyst useful in accordance with the present invention will comprise an aluminum compound of the formula R¹_{b}Al(OR¹)ₐX_{3-(a+b)} wherein a is an integer from 0 to 3, b is an integer from 0 to 3 and the sum of a+b is from 0 to 3, R¹ is the same or different C₁₋₁₀ alkyl radical and X is a chlorine atom, a transition metal, preferably a titanium compound of the formula Ti((O)_{c}R²)_{d}Xₑ wherein R² is selected from the group consisting of C₁₋₄ alkyl radicals, C₆₋₁₀ aromatic radicals and mixtures thereof, X is selected from the group consisting of a chlorine atom and a bromine atom, c is 0 or 1, d is 0 or an integer up to 4 and e is 0 or an integer up to 4 and the sum of d+e is the valence of the Ti atom; a magnesium compound of the formula (R⁵)_{f}Mg X_{2-f} wherein each R⁵ is independently a C₁₋₈ alkyl radical and f is 0, 1 or 2; CCl₄ or an alkyl halide selected from the group consisting of C₃₋₆ secondary or tertiary alkyl halides and optionally an electron donor, a molar ratio of total Al to Ti (e.g. the first and/or second aluminum additions (if two additions are made) Al¹ and Al²—typically if two additions are made from 0 to 60 weight % of the aluminum compound may be used to treat the support and the remaining aluminum is added at some time during the rest of the catalyst synthesis) from 2:1 to 15:1 a molar ratio of Al from the second aluminum (Al²) addition to Ti from 1:1 to 8:1; a molar ratio of Mg:Ti from 0.5:1 to 20:1, preferably 1:1 to 12:1; a molar ratio of active halide (this excludes the halide from the Al and Ti compounds) from the CCl₄ or alkyl halide to Mg from 1:1 to 6:1, preferably 1.5:1 to 5:1; and a molar ratio of electron donor to Ti from 0:1 to 18.1, preferably from 1:1 to 15:1.

Typically the catalyst components are reacted in an organic medium such as an inert C₅₋₁₀ hydrocarbon which may be unsubstituted or is substituted by a C₁₋₄ alkyl radical. Some solvents include pentane, iso-pentane, hexane, isohexane, heptane, octane, cyclohexane, methyl cyclohexane, hydrogenated naphtha and ISOPAR®E (a solvent available from Exxon Chemical Company) and mixtures thereof.

Typically the aluminum compounds useful in the formation of the catalyst or catalyst precursor in accordance with the present invention have the formula R¹_{b}Al(OR¹)ₐX_{3-(a+b)} wherein a is an integer from 0 to 3, b is an integer from 0 to 3 and the sum of a+b is from 0 to 3, R¹ is the same or different C₁₋₁₀ alkyl radical and X is a chlorine atom. Suitable aluminum compounds include, trimethyl aluminum (TMA), triethyl aluminum (TEAL), isoprenyl aluminum, tri-isobutyl aluminum (TiBAL), diethyl aluminum chloride (DEAC), tri-n-hexyl aluminum (TnHAl), tri-n-octyl aluminum (TnOAl), diethyl aluminum ethoxide and mixtures thereof. The aluminum compounds containing a halide may be an aluminum sesqui-halide. Preferably, in the aluminum compound a is 0, b is 3 and R¹ is a C₁₋₈ alkyl radical.

The magnesium compound may be a compound of the formula (R⁵)_{f}MgX_{2-f} wherein each R⁵ is independently selected from the group consisting of C₁₋₈ alkyl radicals and f is 0, 1 or 2. Some commercially available magnesium compounds include magnesium chloride, butyl octyl magnesium, dibutyl magnesium and butyl ethyl magnesium. If the magnesium compound is soluble in the organic solvent it may be used in conjunction with a halogenating agent or reactive organic halide to form magnesium halide (i.e. MgX₂ where X is a halogen preferably chlorine or bromine, most preferably chlorine), which precipitates from the solution (potentially forming a substrate for the Ti compound). Some halogenating agents include CCl₄ or a secondary or tertiary halide of the formula R⁶Cl wherein R⁶ is selected from the group consisting of secondary and tertiary C₃₋₆ alkyl radicals. Suitable chlorides include sec-butyl chloride, t-butyl chloride and sec-propyl chloride. The reactive halide is added to the catalyst in a quantity such that the active Cl:Mg molar ratio should be from 1.5:1 to 5:1, preferably from 1.75:1 to 4:1, most preferably from 1.9:1 to 3.5:1.

The titanium compound in the catalyst may have the formula Ti((O)_{c}R²)_{d}Xₑ wherein R² is selected from the group consisting of C₁₋₄ alkyl radicals, C₆₋₁₀ aromatic radicals and mixtures thereof, X is selected from the group consisting of a chlorine atom and a bromine atom, c is 0 or 1, d is 0 or an integer up to 4 and e is 0 or an integer up to 4 and the sum of d+e is the valence of the Ti atom. If c is 1 the formula becomes Ti(OR²)_{d}Xₑ wherein R² is selected from the group consisting of C₁₋₄ alkyl radicals, and C₁₋₁₀ aromatic radicals, X is selected from the group consisting of a chlorine atom and a bromine atom, preferably a chlorine atom, d is 0 or an integer up to 4 and e is 0 or an integer up to 4 and the sum of d+e is the valence of the Ti atom. The titanium compound may be selected from the group consisting of TiCl₃, TiCl₄, Ti(OC₄H₉)₄, Ti(OC₃H₇)₄, and Ti(OC₄H₉)Cl₃ and mixtures thereof. Most preferably the titanium compound is selected from the group consisting of Ti(OC₄H₉)₄ and TiCl₄ and mixtures thereof. Generally, the titanium in the catalyst or catalyst precursor is present in an amount from 0.20 to 5, preferably from 0.20 to 4, most preferably from 0.25 to 3.5 weight % based on the final weight of the catalyst (including the support).

The above catalyst system may be prepolymerized prior to being fed to the reactor. This process is well known to those skilled in the art. For example BP EP9974, Basell WO 02/074818 A1 and Montel U.S. Pat. No. 5,733,987 disclose such processes. By prepolymerizing the weight ratios of the components in the catalyst or catalyst precursor while initially within the above ranges may be reduced due to the presence of the formed prepolymer.

As noted above, an electron donor may be, and in fact is preferably used in the catalysts or catalysts precursor used in accordance with the present invention. The electron donor may be selected from the group consisting of C₃₋₁₈ linear or cyclic aliphatic or aromatic ethers, ketones, esters, aldehydes, amides, nitrites, amines, phosphines or siloxanes. Preferably, the electron donor is selected from the group consisting of diethyl ether, triethyl amine, 1,4-dioxane, tetrahydrofuran, acetone, ethyl acetate, and cyclohexanone and mixtures thereof. The electron donor may be used in a molar ratio to the titanium from 0:1 to 18:1 preferably in a molar ratio to Ti from 3:1 to 15:1, most preferably from 3:1 to 12:1.

In the catalyst or catalyst precursor the molar ratio of Mg:Ti may be from 0.5:1 to 20:1, preferably from 1:1 to 12:1, most preferably from 1:1 to 10:1. If a second aluminum addition is used the molar ratio of second aluminum (Al²) to titanium in the catalyst may be from 1:1 to 8:1, preferably from 1.5:1 to 7:1, most preferably from 2:1 to 6:1. Generally, from 0 to not more than about 60 weight %, preferably from 10 to 50 weight %, of the aluminum (compound in the catalyst) may be used to treat the support (e.g. Al¹). The molar ratio of active halide (from the alkyl halide or CCl₄) to Mg may be from 1.5:1 to 5:1 preferably from 1.75:1 to 4:1, most preferably from 1.9:1 to 3.5:1. The molar ratio of electron donor, if present, to Ti may be from 1:1 to 15:1, most preferably from 3:1 to 12:1.

The Ziegler-Natta catalyst may be activated with one or more co-catalysts of the formula Al(R⁷)_{3-g}X_{g} wherein R⁷ is a C₁₋₆ alkyl radical, X is a chlorine atom and g is 0 or 1 and mixtures thereof. The co-catalyst may be selected from the group consisting of tri C₁₋₆ alkyl aluminums, alkyl aluminum chlorides (e.g. di C₁₋₆ alkyl aluminum chloride), and mixtures thereof. This includes, but is not limited to, trimethyl aluminum, triethyl aluminum, tri propyl aluminum, tributyl aluminum, tri isobutyl aluminum, isoprenylaluminum, n-hexyl aluminum, diethyl aluminum chloride, dibutyl aluminum chloride, and mixtures thereof. A preferred co-catalyst is triethyl aluminum.

The co-catalyst may be fed to the reactor to provide from 10 to 130, preferably 10 to 80 more preferably from 15 to 70, most preferably from 20 to 60 ppm of aluminum (Al ppm) based on the polymer production rate.

The present invention may use a catalyst which is a bulky ligand single site catalyst. Such catalysts are generally used on a support as described above.

The bulky ligand single site catalysts may have the formula:
(L)ₙ—M—(Y)ₚ
wherein M is selected from the group consisting of Ti, Zr and Hf; L is a monoanionic ligand independently selected from the group consisting of cyclopentadienyl-type ligands, and a bulky heteroatom ligand containing not less than five atoms in total (typically of which at least 20%, preferably at least 25% numerically are carbon atoms) and further containing at least one heteroatom selected from the group consisting of boron, nitrogen, oxygen, phosphorus, sulfur and silicon, said bulky heteroatom ligand being sigma or pi-bonded to M, Y is independently selected from the group consisting of activatable ligands; n may be from 1 to 3; and p may be from 1 to 3, provided that the sum of n+p equals the valence state of M, and further provided that two L ligands may be bridged for example by a silyl radical or a C₁₋₄ alkyl radical, or a mixture thereof.

The term “cyclopentadienyl” refers to a 5-member carbon ring having delocalized bonding within the ring and typically being bound to the active catalyst site, generally a group 4 metal (M) through η⁵- bonds. The cyclopentadienyl ligand may be unsubstituted or up to fully substituted with one or more substituents independently selected from the group consisting of C₁₋₁₀ hydrocarbyl radicals which hydrocarbyl substituents are unsubstituted or further substituted by one or more substituents independently selected from the group consisting of a halogen atom and a C₁₋₄ alkyl radical; a halogen atom; a C₁₋₈ alkoxy radical; a C₆₋₁₀ aryl or aryloxy radical; an amido radical which is unsubstituted or substituted by up to two C₁₋₈ alkyl radicals; a phosphido radical which is unsubstituted or substituted by up to two C₁₋₈ alkyl radicals; silyl radicals of the formula —Si—(R)₃ wherein each R is independently selected from the group consisting of hydrogen, a C₁₋₈ alkyl or alkoxy radical, and C₆₋₁₀ aryl or aryloxy radicals; and germanyl radicals of the formula Ge—(R)₃ wherein R is as defined above.

Typically the cyclopentadienyl-type ligand is selected from the group consisting of a cyclopentadienyl radical, an indenyl radical and a fluorenyl radical which radicals are unsubstituted or up to fully substituted by one or more substituents independently selected from the group consisting of a fluorine atom, a chlorine atom; C₁₋₄ alkyl radicals; and a phenyl or benzyl radical which is unsubstituted or substituted by one or more fluorine atoms.

In the formula above if none of the L ligands is bulky heteroatom ligand then the catalyst could be a mono cyclopentadienyl (Cp) catalyst, a bridged or unbridged bis Cp catalyst or a bridged constrained geometry type catalysts or a tris Cp catalyst.

If the catalyst contains one or more bulky heteroatom ligands the catalyst would have the formula: 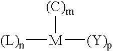
wherein M is a transition metal selected from the group consisting of Ti, Hf and Zr; C is a bulky heteroatom ligand preferably independently selected from the group consisting of phosphinimine ligands (as described below) and ketimide ligands (as described below); L is a monoanionic ligand independently selected from the group consisting of cyclopentadienyl-type ligands; Y is independently selected from the group consisting of activatable ligands; m is 1 or 2; n is 0 or 1; and p is an integer and the sum of m+n+p equals the valence state of M, provided that when m is 2, C may be the same or different bulky heteroatom ligands.

For example, the catalyst may be a bis (phosphinimine), a bis (ketimide), or a mixed phosphinimine ketimide dichloride complex of titanium, zirconium or hafnium. Alternately, the catalyst could contain one phosphinimine ligand or one ketimide ligand, one “L” ligand (which is most preferably a cyclopentadienyl-type ligand) and two “Y” ligands (which are preferably both chloride).

The preferred metals (M) are from Group 4 (especially titanium, hafnium or zirconium) with titanium being most preferred. In one embodiment the catalysts are group 4 metal complexes in the highest oxidation state.

The catalyst may contain one or two phosphinimine ligands (Pl) which are bonded to the metal. The phosphinimine ligand is defined by the formula: 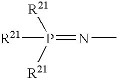
wherein each R²¹ is independently selected from the group consisting of a hydrogen atom; a halogen atom; C₁₋₂₀, preferably C₁₋₁₀ hydrocarbyl radicals which are unsubstituted by or further substituted by a halogen atom; a C₁₋₈ alkoxy radical; a C₆₋₁₀ aryl or aryloxy radical; an amido radical; a silyl radical of the formula:
—Si—(R²²)₃
wherein each R²² is independently selected from the group consisting of hydrogen, a C₁₋₈ alkyl or alkoxy radical, and C₆₋₁₀ aryl or aryloxy radicals; and a germanyl radical of the formula:
—Ge—(R²²)₃
wherein R²² is as defined above.
The preferred phosphinimines are those in which each R²¹ is a hydrocarbyl radical, preferably a C₁₋₆ hydrocarbyl radical, such as a t-butyl radical.

Suitable phosphinimine catalysts are Group 4 organometallic complexes which contain one phosphinimine ligand (as described above) and one ligand L which is either a cyclopentadienyl-type ligand or a heteroatom ligand.

As used herein, the term “ketimide ligand” refers to a ligand which:

(a) is bonded to the transition metal via a metal-nitrogen atom bond;

(b) has a single substituent on the nitrogen atom (where this single substituent is a carbon atom which is doubly bonded to the N atom); and

(c) has two substituents Sub 1 and Sub 2 (described below) which are bonded to the carbon atom.

Conditions a, b and c are illustrated below:

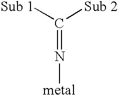

The substituents “Sub 1” and “Sub 2” may be the same or different. Exemplary substituents include hydrocarbyls having from 1 to 20, preferably from 3 to 6, carbon atoms, silyl groups (as described below), amido groups (as described below) and phosphido groups (as described below). For reasons of cost and convenience it is preferred that these substituents both be hydrocarbyls, especially simple alkyls radicals and most preferably tertiary butyl radicals.

Suitable ketimide catalysts are Group 4 organometallic complexes which contain one ketimide ligand (as described above) and one ligand L which is either a cyclopentadienyl-type ligand or a heteroatom ligand.

The term bulky heteroatom ligand is not limited to phosphinimine or ketimide ligands and includes ligands which contain at least one heteroatom selected from the group consisting of boron, nitrogen, oxygen, phosphorus, sulfur or silicon. The heteroatom ligand may be sigma or pi-bonded to the metal. Exemplary heteroatom ligands include silicon-containing heteroatom ligands, amido ligands, alkoxy ligands, boron heterocyclic ligands and phosphole ligands, as all described below.

Silicon containing heteroatom ligands are defined by the formula:
—(Y)SiRₓR_{y}R_{Z}
wherein the — denotes a bond to the transition metal and Y is sulfur or oxygen.

The substituents on the Si atom, namely Rₓ, R_{y} and R_{z} are required in order to satisfy the bonding orbital of the Si atom. The use of any particular substituent Rₓ, R_{y} or R_{z} is not especially important to the success of this invention. It is preferred that each of Rₓ, R_{y} and R_{z} is a C₁₋₂ hydrocarbyl group (i.e. methyl or ethyl) simply because such materials are readily synthesized from commercially available materials.

The term “amido” is meant to convey its broad, conventional meaning. Thus, these ligands are characterized by (a) a metal-nitrogen bond; and (b) the presence of two substituents (which are typically simple alkyl or silyl groups) on the nitrogen atom.

The terms “alkoxy” and “aryloxy” is also intended to convey its conventional meaning. Thus, these ligands are characterized by (a) a metal oxygen bond; and (b) the presence of a hydrocarbyl group bonded to the oxygen atom. The hydrocarbyl group may be a C₁₋₁₀ straight chained, branched or cyclic alkyl radical or a C₆₋₁₃ aromatic radical which radicals are unsubstituted or further substituted by one or more C₁₋₄ alkyl radicals (e.g. 2,6 di-tertiary butyl phenoxy).

Boron heterocyclic ligands are characterized by the presence of a boron atom in a closed ring ligand. This definition includes heterocyclic ligands which may also contain a nitrogen atom in the ring. These ligands are well known to those skilled in the art of olefin polymerization and are fully described in the literature (see, for example, U.S. Pat. Nos. 5,637,659; 5,554,775; and the references cited therein).

The term “phosphole” is also meant to convey its conventional meaning. “Phospholes” are cyclic dienyl structures having four carbon atoms and one phosphorus atom in the closed ring. The simplest phosphole is C₄PH₄ (which is analogous to cyclopentadiene with one carbon in the ring being replaced by phosphorus). The phosphole ligands may be substituted with, for example, C₁₋₂₀ hydrocarbyl radicals (which may, optionally, contain halogen substituents); phosphido radicals; amido radicals; or silyl or alkoxy radicals. Phosphole ligands are also well known to those skilled in the art of olefin polymerization and are described as such in U.S. Pat. No. 5,434,116 (Sone, to Tosoh).

The term “activatable ligand” (i.e. “Y” in the above formula) or “leaving ligand” refers to a ligand which may be activated by the aluminoxane (also referred to as an “activator”) to facilitate olefin polymerization. Exemplary activatable ligands are independently selected from the group consisting of a hydrogen atom; a halogen atom, preferably a chlorine or fluorine atom; a C₁₋₁₀ hydrocarbyl radical, preferably a C₁₋₄ alkyl radical; a C₁₋₁₀ alkoxy radical, preferably a C₁₋₄ alkoxy radical; and a C₅₋₁₀ aryl oxide radical; each of which said hydrocarbyl, alkoxy, and aryl oxide radicals may be unsubstituted by or further substituted by one or more substituents selected from the group consisting of a halogen atom, preferably a chlorine or fluorine atom; a C₁₋₈ alkyl radical, preferably a C₁₋₄ alkyl radical; a C₁₋₈ alkoxy radical, preferably a C₁₋₄ alkoxy radical; a C₆₋₁₀ aryl or aryloxy radical; an amido radical which is unsubstituted or substituted by up to two C₁₋₈, preferably C₁₋₄ alkyl radicals; and a phosphido radical which is unsubstituted or substituted by up to two C₁₋₈, preferably C₁₋₄ alkyl radicals.

The number of activatable ligands (Y) depends upon the valency of the metal and the valency of the activatable ligand. The preferred catalyst metals are Group 4 metals in their highest oxidation state (i.e. 4⁺) and the preferred activatable ligands are monoanionic (such as a halide—especially chloride or C₁₋₄ alkyl—especially methyl).

In one embodiment of the present invention the transition metal complex may have the formula: [(Cp)ₙM[N=P(R²¹)]ₘYₚ wherein M is the transition (group 4) metal; Cp is a C₅₋₁₃ ligand containing a 5-membered carbon ring having delocalized bonding within the ring and bound to the metal atom through covalent η⁵ bonds and said ligand being unsubstituted or up to fully 4 substituted with one or more substituents selected from the group consisting of a halogen atom, preferably chlorine or fluorine; C₁₋₄ alkyl radicals; and benzyl and phenyl radicals which are unsubstituted or substituted by one or more halogen atoms, preferably fluorine; R²¹ is a substituent selected from the group consisting of C₁₋₆ straight chained or branched alkyl radicals, C₆₋₁₀ aryl and aryloxy radicals which are unsubstituted or may be substituted by up to three C₁₋₄ alkyl radicals, and silyl radicals of the formula —Si—(R)₃ wherein R is C₁₋₄ alkyl radical or a phenyl radical; Y is selected from the group consisting of a leaving ligand; n is 1 or 2; m is 1 or 2; and the valence of the transition metal—(n+m)=p.

For the single site type catalyst the activator may be a complex aluminum compound of the formula R¹²₂AlO(R¹²AlO)_{q}AlR¹²₂ wherein each R¹² is independently selected from the group consisting of C₁₋₂₀ hydrocarbyl radicals and q is from 3 to 50.

In the aluminum compound preferably, R¹² is a methyl radical and q is from 10 to 40.

The catalysts systems in accordance with the present invention may have a molar ratio of aluminum from the aluminoxane to transition metal from 5:1 to 1000:1, preferably from 10:1 to 500:1, most preferably from 30:1 to 300:1, most desirably from 50:1 to 120:1.

The phrase “and mixtures thereof” in relation to the catalyst mean the catalyst may be a mixture of one or more chromium catalysts, a mixture of one or more Ziegler-Natta catalysts, a mixture of one or more bulky ligand single site catalysts, a mixture of one or more chromium catalysts with one or more Ziegler Natta catalysts, a mixture of one or more Ziegler-Natta catalysts with one or more bulky ligand single site catalysts and a mixture of one or more chromium catalysts with one or more bulky ligand single site catalysts.

The resulting polymer may be compounded with conventional heat and light stabilizers (antioxidants) and UV stabilizers in conventional amounts. Typically the antioxidant may comprise a hindered phenol and a secondary antioxidant generally in a weight ratio of about 0.5:1 to 5:1 and the total amount of antioxidant may be from 200 to 3,000 ppm. Generally, the UV stabilizer may be used in amounts from 100 to 1,000 ppm.

The present invention will now be illustrated by the following non-limiting examples. In the examples, unless otherwise indicated, parts means parts by weight (i.e. grams) and percent means weight percent.

Catalysts

The catalysts used in this work were all manufactured similar to that described by example 3 in EP 1350802 A1.

### EXAMPLE 1

The HDPE bench scale reactions were conducted in a 2 L stirred bed catalytic reactor at 85° C. containing hydrogen (50 psi), ethylene (200 psi), hexane (inert hydrocarbon) and nitrogen (balance gas) at a hydrogen to ethylene (H₂/C₂) gas phase molar ratio of 0.25. The amounts of catalyst used were 45 mg while the co-catalyst (TEAL) was used at an Al:Ti ratio of 50:1 for all experiments. The polymerization was continued for 1 hour at which time the feed gases were stopped and the reactor was vented. The rates of consumption of ethylene, which provide an indication of the polymerization rate, over the one-hour reaction time from these HDPE experiments, are plotted in FIG. 1. The results show that the productivity increased from 200 gPE/gCat in the absence of hexane to 575 gPE/gCat when hexane level was increased to 50 ml. A further increase of hexane to 75 ml boosted the productivity in excess of 3,100 gPE/gCat, which is, more than 15 times without hexane. These results show that the presence of inert liquid hydrocarbon in the reactor increases the productivity of the catalyst significantly in HDPE polymerization.

### EXAMPLE 2

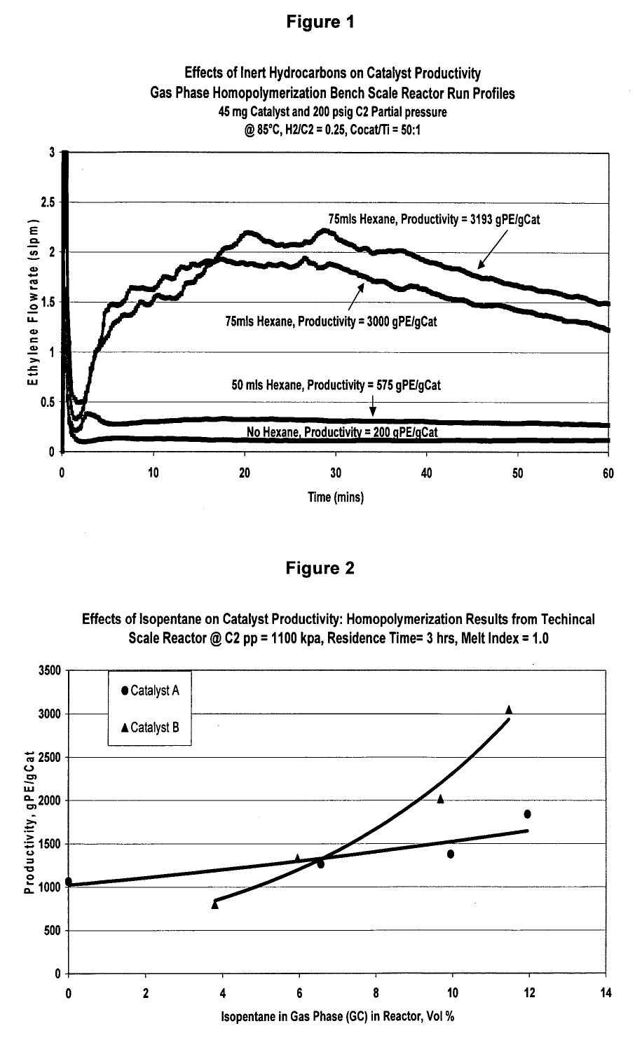

The effect of iso-pentane on the productivity of two different Ziegler-Natta catalysts in a technical scale reactor (TSR) gas phase polymerization of HDPE was also studied. Experiments were conducted in a 75 L stirred bed catalytic reactor similar to that described in EP 0 659 773. The HDPE polymerizations were conducted at 96° C. with the reactor containing hydrogen, ethylene, iso-pentane as the inert hydrocarbon and TEAL as co-catalyst to obtain HDPE resins. Nitrogen was used to maintain the total reactor pressure to approximately 2,100 kPa. Iso-pentane was injected as a liquid into the reactor and the amount of iso-pentane was varied in each experiment. The results are summarized in FIG. 2. The data in FIG. 2 support the conclusion that the catalyst productivity is enhanced with the injection of iso-pentane into the reactor for both Ziegler-Natta catalysts. The degree of productivity enhancement appeared different for different catalysts but in both cases, the productivity increased with iso-pentane level.

### EXAMPLE 3

A further study was conducted to demonstrate the effect of increasing the level of iso-pentane as well as the form of the iso-pentane on productivity and fines in the TSR in the presence of a Ziegler-Natta catalyst under HDPE polymerization conditions. The experiments were conducted in a 75 L stirred bed catalytic reactor similar to that described in EP 0 659 773. The polymerizations were conducted at 98° C. with the reactor containing hydrogen, ethylene, a small amount of butene comonomer with and without iso-pentane as the inert hydrocarbon and TEAL as co-catalyst to produce HDPE resins. Nitrogen was used to maintain the total reactor pressure to approximately 2,100 kPa. The results of the experiments are summarized in FIG. 3 and they clearly show the impact of iso-pentane as well as the phase (liquid versus gas) of the iso-pentane on catalyst productivity. When iso-pentane was introduced into the reactor as a liquid, the impact on productivity enhancement was even greater than when it was delivered in the gaseous form. For example, when iso-pentane was injected as a gas, the productivity increased by 11% compared to no iso-pentane. However, when the iso-pentane was injected in a liquid form, the improvement in productivity is 68% compared to no iso-pentane and 51% compared to iso-pentane gas injection. For the case with liquid iso-pentane, the hydrocarbon liquid was injected directly into the reactor. For the case with iso-pentane gas injection, the injection line was heated using heating tapes wrapped around the line. The gas temperature was controlled to a temperature higher than the dew point of the stream. In addition to improving catalyst productivity, the fines level in the reactor also decreased when the level of iso-pentane was increased. The reduced fines level translated into improved reactor operability in terms of reduced particle agglomeration, reactor fouling and sheeting during gas phase polymerization of HDPE resins.

### EXAMPLE 4

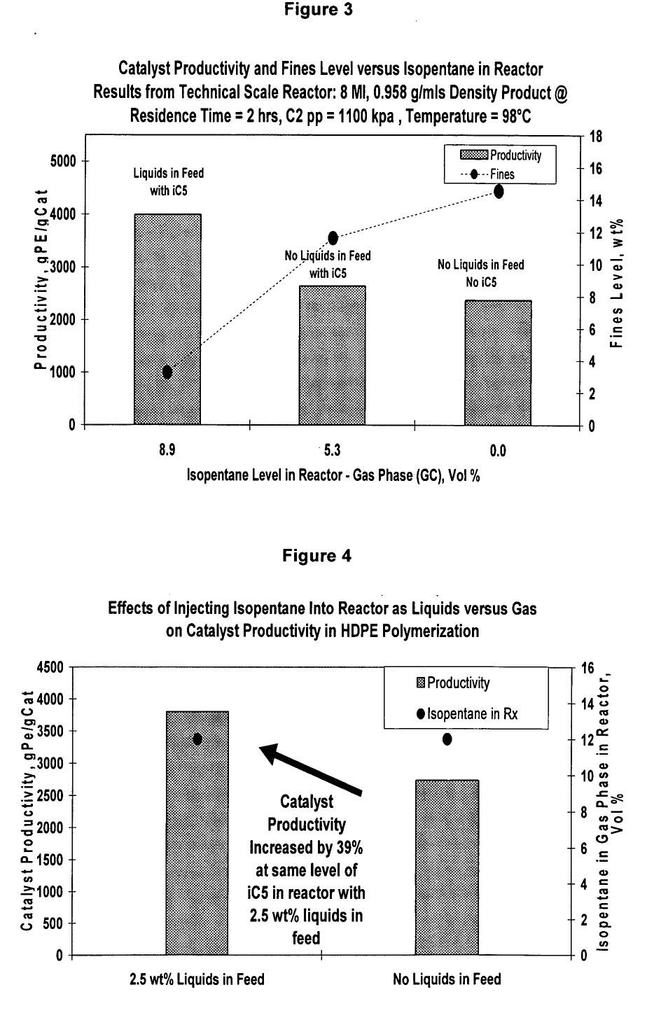

Additional studies were conducted to further demonstrate the effects of injecting some liquids into the polymerization reactor compared to an entirely gaseous feedstream on catalyst productivity in HDPE polymerization reactions. Experiments were conducted in a 75 L stirred bed catalytic reactor similar to that described in EP 0 659 773. The HDPE polymerizations were conducted at 98° C. with the reactor containing hydrogen, ethylene, butene comonomer, iso-pentane as the inert hydrocarbon and TEAL as co-catalyst. Nitrogen was used to maintain the total reactor pressure to approximately 2,100 kPa. The inert hydrocarbon (iso-pentane) was injected into the reactor in liquid form or gaseous form in two separate experiments. The objective was to demonstrate that productivity enhancement by liquids injection can be consistently achieved when producing high-density (HDPE) resins. Results in FIG. 4 clearly show that catalyst productivity in HDPE polymerization was improved (by 39%) when the iso-pentane was introduced into the reactor in liquid form compared to gaseous form at the same final level of iso-pentane in the reactor gas phase. For the case with iso-pentane injected as gas, the liquid was heated using heating tapes wrapped around the injection line and the temperature of the gas was controlled to a temperature higher than the dew point of the stream.

### EXAMPLE 5

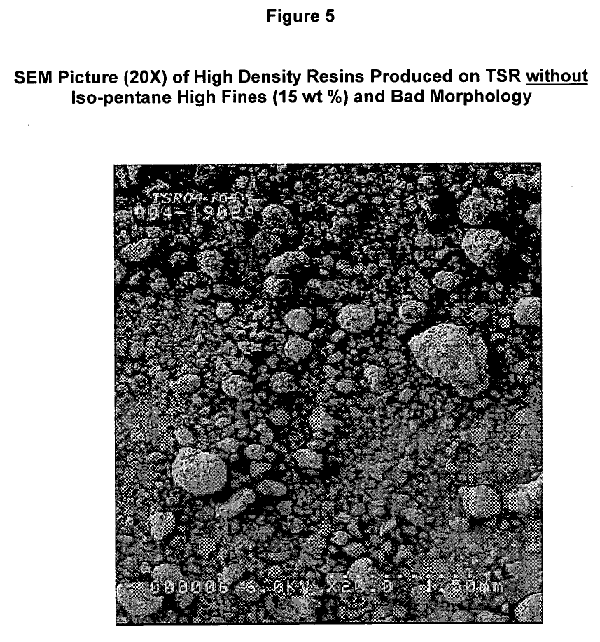

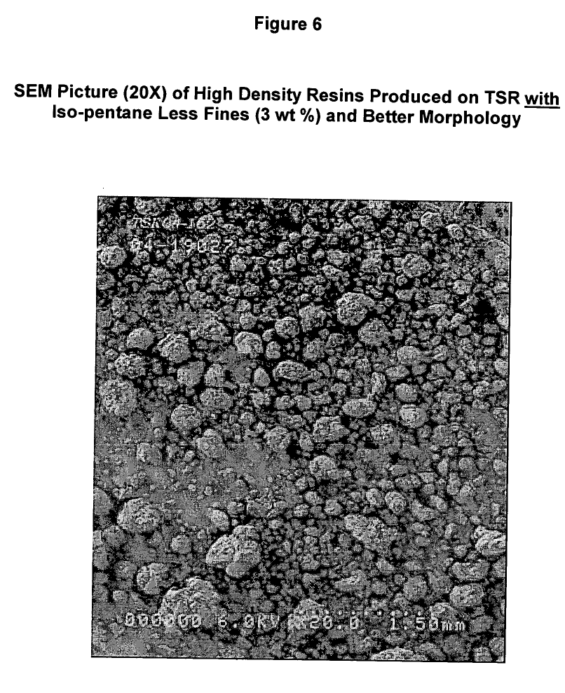

Experiments to demonstrate the impact of a non-polymerizable hydrocarbon in the reactor on particle morphology of HDPE resins were carried out on the TSR in the presence of a Ziegler-Natta catalyst. Experiments were conducted in a 75 L stirred bed catalytic reactor similar to that described in EP 0 659 773. The HDPE polymerizations were conducted at 98° C. with the reactor containing hydrogen, ethylene, small amount of butene comonomer, iso-pentane as the inert hydrocarbon and TEAL as co-catalyst. Nitrogen was used to maintain the total reactor pressure to approximately 2,100 kPa. Iso-pentane was not used in the first experiment while 3 weight % of iso-pentane was injected into the reactor in liquid form in the second experiment. The particle morphology was examined using a Scanning Electron Microscope (SEM) and results can be found in FIGS. 5 and 6. The SEM pictures clearly reveal that the particle breakage in the reactor was reduced significantly with iso-pentane. Measurement of the fines level also showed that iso-pentane reduced the fines to 3 weight % (with iso-pentane) from 15 weight % (without iso-pentane). While not bound by theory, it appears that the iso-pentane liquids are soaked into the growing polymer particles and thereby improve particle heat removal efficiency during polymerization. On the other hand, the presence of iso-pentane may change the crystalline structure of the polymer particle and make the polymer particle less brittle, and therefore result in fewer fines. The presence of hydrocarbon liquids in the polymer is believed to moderate the rate of initial particle growth and temperature excursions within the polymer particle. High initial activity surges may cause particles to expand too fast thus leading to particle fragmentation, high fines and irregular shaped particles. This phenomenon has been repeatedly observed on the TSR.

Examples of possible improvements to process operability that can be realized with lower fines and better particle morphology in the presence of inert hydrocarbon/liquids in reactor are as follows:
HDPE resins are recognized for fines generation due to the brittleness of the polymer. Reduction of fines generation in the reactor may decrease carryover of fines in the recycle loop leading to reduction of polymer build-up in heat exchanger, separator, compressor, pipes etc.
Reduction of fine particles may also reduce the chances of particles adhering to reactor walls leading to reduced sheeting or polymer build-up on the walls.
Presence of inert hydrocarbon and liquids in reactor may reduce static generation leading to reduced sheeting/agglomeration.
Good particle morphology may further reduce fines generation in post reactor operations such as purge bins, conveying system, extruder, etc.

### EXAMPLE 6

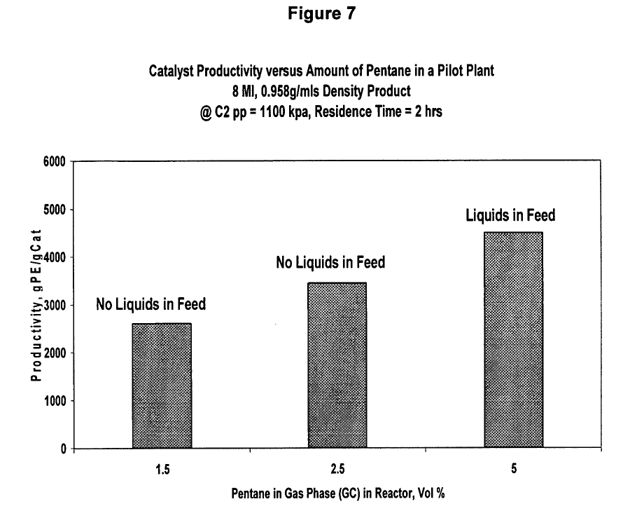

FIG. 7 shows the effect of adding iso-pentane to a pilot plant reactor similar to that described in EP 824118 when preparing HDPE in the presence of a Ziegler Natta catalyst. Similar to results obtained from HDPE polymerization on the technical scale reactor (TSR), the productivity of the catalyst improved in the presence of gaseous pentane in the reactor and further improved by the presence of liquid pentane in the feed stream. The operability (in terms of reduced agglomerations and sheets formation) also improved when liquid pentane was injected into the reactor.

In the examples above, the liquefied hydrocarbons are injected into the reactor to improve catalyst productivity and reactor operability. Specifically, the purpose of the liquid hydrocarbon is not to increase the production rate or space-time yield (STY) of the polymerization processes. As such the above examples show that the catalyst productivity and reactor operability can be improved without significantly increasing (typically less than 5%) the space time yield (STY, i.e. production rate per fluidized reactor bed volume) during polymerization of HDPE resins having a density greater than about 0.940 g/cc.

1. A method to improve the operability in terms of fines, agglomerations, sheet formation and reactor fouling of a gas phase fluidized bed olefin polymerization process conducted at a temperature from 85° C. to 120° C. and a reactor pressure from 100 to 300 psig in the presence of a catalyst selected from the group consisting of chromium catalysts, Ziegler-Natta catalyst, Ti, Zr, and Hf, bulky ligand single site catalysts and a mixture thereof including a recycle stream wherein the resulting polyolefin has a density greater than 0.940 g/cc without increasing the production rate per fluidized bed reactor volume (kg/hr/m³) by more than 5% comprising conducting the polymerization in the presence of 1 to 20 weight % of a C₃₋₈ alkane based on the recycle stream.

2. (canceled)

3. The method according to claim 1, wherein the polyolefin has a density greater than 0.945 g/cc.

4. The method according to claim 3, wherein the polyolefin comprises from 100 to 94 weight % of ethylene and from 0 to 6 weight % of one or more monomers selected from the group consisting of C₃₋₈ alpha olefins.

5. (canceled)

6. (canceled)

7. A method to improve the productivity of a catalyst in a gas phase fluidized bed olefin polymerization process conducted at a temperature from 85° C. to 120° C. and a reactor pressure from 100 to 300 psig in the presence of a catalyst selected from the group consisting of chromium catalysts, Zieciler-Natta catalyst, Ti, Zr, and Hf, bulky ligand single site catalysts and a mixture thereof including a recycle stream wherein the resulting polyolefin has a density greater than 0.940 g/cc without increasing the production rate per fluidized bed reactor volume (kg/hr/m³) by more than 5% comprising conducting the polymerization in the presence of from 1 to 20 weight % of a C₃₋₈ alkane based on the recycle stream.

8. (canceled)

9. The method according to claim 7, wherein the polyolefin has a density greater than 0.945 g/cc.

10. The method according to claim 9, wherein the polyolefin comprises from 100 to 94 weight % of ethylene and from 0 to 6 weight % of one or more monomers selected from the group consisting of C₃₋₈ alpha olefins.

11. (canceled)

12. (canceled)

13. The method according to claim 10, wherein the catalyst is a chromium catalyst.

14. The method according to claim 13, wherein the chromium catalyst is supported on an inorganic support having an average particle size from about 10 to 150 microns, a surface area greater than 100 m²/g, a pore volume from about 0.3 to 5.0 ml/g, a surface hydroxyl content from about 0.1 to 5 mmol/g of support.

15. The method according to claim 14, wherein the comonomer is selected from the group consisting of C₄₋₆ alpha olefins and is present in the polymer in an amount of less than 5 weight %.

16. (canceled)

17. The method according to claim 10, wherein the catalyst is a Ziegler-Natta catalyst comprising a transition metal compound of the formula Ti((O)_{c}R²)_{d}Xₑ wherein R² is selected from the group consisting of C₁₋₄ alkyl radicals, C₆₋₁₀ aromatic radicals and mixtures thereof, X is selected from the group consisting of a chlorine atom and a bromine atom, c is 0 or 1, d is 0 or an integer up to 4 and e is 0 or an integer up to 4 and the sum of d+e is the valence of the Ti atom; a magnesium compound of the formula (R⁵)_{f}MgX_{2-f} wherein each R⁵ is independently a C₁₋₈ alkyl radical and f is 0, 1 or 2 and X is a chlorine or bromine atom; a reactive halide selected from the group consisting of CCl₄ and C₁₋₆ alkyl halides; and optionally an electron donor on an organic or inorganic support.

18. The method according to claim 17, wherein the Ziegler-Natta catalyst is activated with one or more co-catalyst of the formula Al(R⁷)_{3-g}X_{g} wherein R⁷ is a C₁₋₆ alkyl radical, X is a chlorine atom and g is 0 or 1 and mixtures thereof.

19. The method according to claim 18, wherein in the catalyst the titanium component is selected from the group consisting of TiCl₃, TiCl₄, Ti(OC₄H₉)₄, Ti(OC₃H₇)₄ and mixtures thereof.

20. The method according to claim 19, wherein in the catalyst the aluminum compound is selected from the group consisting of trimethyl aluminum, triethyl aluminum, diethyl aluminum ethoxide, tri iso-butyl aluminum, isoprenyl aluminum, tri-n-hexyl aluminum, tri-n-octyl aluminum, diethyl aluminum chloride and mixtures thereof.

21. The method according to claim 20, wherein in the catalyst the magnesium compound is selected from the group consisting of magnesium chloride, butyl octyl magnesium, dibutyl magnesium and butyl ethyl magnesium, provided if the magnesium compound is other than magnesium chloride the reactive alkyl halide is present in an amount to provide a molar ratio of active halogen:Mg from 1.5:1 to 3:1.

22. The method according to claim 21, wherein in the catalyst the reactive alkyl halide is a C₃₋₆ secondary or tertiary alkyl chloride.

23. The method according to claim 22, wherein the electron donor is present and is selected from the group consisting of C₃₋₁₈ linear or cyclic, aliphatic or aromatic ethers, ketones, esters, aldehydes, amides, nitriles, amines, phosphines or siloxanes.

24. The method according to claim 23, wherein the support is an inorganic support having an average particle size from about 10 to 150 microns, a surface area greater than 100 m²/g, a pore volume from about 0.3 to 5.0 ml/g, a surface hydroxyl content from about 0.1 to 5 mmol/g of support.

25. The method according to claim 24, wherein the support is treated with an aluminum compound of the formula R¹_{b}Al(OR¹)ₐX_{3-(a+b)} wherein a is an integer from 0 to 3, b is an integer from 0 to 3 and the sum of a+b is from 0 to 3, R¹ is the same or different C₁₋₁₀ alkyl radical and X is a chlorine atom.

26. The method according to claim 25, wherein the catalyst has a molar ratio of total Al to Ti from 2:1 to 15:1; a molar ratio of Mg:Ti from 0.5:1 to 20:1; a molar ratio of halide to Mg from 1:1 to 6:1; a molar ratio of electron donor to Ti from 0:1 to 18:1 and the titanium is present in the catalyst in an amount from 0.20 to 5 weight % inclusive of the support.

27. The method according to claim 26, wherein the comonomer is selected from the group consisting of C₄₋₆ alpha olefins and is present in the polymer in an amount of less than 5 weight %.

28. (canceled)

29. The method according to claim 10, wherein the catalyst is one or more bulky ligand single site catalysts of the formula:
(L)ₙ—M—(Y)ₚ
wherein M is selected from the group consisting of Ti, Zr and Hf; L is a monoanionic ligand independently selected from the group consisting of cyclopentadienyl-type ligands, and a bulky heteroatom ligand containing not less than five atoms in total and further containing at least one heteroatom selected from the group consisting of boron, nitrogen, oxygen, phosphorus, sulfur and silicon said bulky heteroatom ligand being sigma or pi-bonded to M, Y is independently selected from the group consisting of activatable ligands; n may be from 1 to 3; and p may be from 1 to 3, provided that the sum of n+p equals the valence state of M, and further provided that two L ligands may be bridged.

30. The method according to claim 29, wherein the catalyst is activated with a complex aluminum compound of the formula:
R¹²₂AlO(R¹²AlO)_{q}AlR¹²₂
wherein each R¹² is independently selected from the group consisting of C₁₋₂₀ hydrocarbyl radicals and q is from 3 to 50, and optionally a hindered phenol to provide a molar ratio of Al:hindered phenol from 2:1 to 5:1 if the hindered phenol is present.

31. The method according to claim 30, wherein the molar ratio of Al to transition metal is from 10:1 to 500:1.

32. The method according to claim 31, wherein the comonomer is selected from the group consisting of C₄₋₆ alpha olefins and is present in the polymer in an amount of less than 5 weight %.

33. (canceled)

34. The method according to claim 32, wherein Y is selected from the group consisting of a hydrogen atom; a halogen atom, preferably a chlorine or fluorine atom; a C₁₋₁₀ hydrocarbyl radical; a C₁₋₁₀ alkoxy radical; a C₅₋₁₀ aryl oxide radical; each of which said hydrocarbyl, alkoxy, and aryl oxide radicals may be unsubstituted by or further substituted by one or more substituents selected from the group consisting of a halogen atom; a C₁₋₈ alkyl radical; a C₁₋₈ alkoxy radical; a C₆₋₁₀ aryl or aryloxy radical; an amido radical which is unsubstituted or substituted by up to two C₁₋₈ alkyl radicals; and a phosphido radical which is unsubstituted or substituted by up to two C₁₋₈ alkyl radicals.

35. The method according to claim 34, wherein in the catalyst the cyclopentadienyl-type ligand is a C₅₋₁₃ ligand containing a 5-membered carbon ring having delocalized bonding within the ring and bound to the metal atom through covalent ηη⁵ bonds and said ligand being unsubstituted or up to fully substituted with one or more substituents selected from the group consisting of C₁₋₁₀ hydrocarbyl radicals in which hydrocarbyl substituents are unsubstituted or further substituted by one or more substituents selected from the group consisting of a halogen atom and a C₁₋₄ alkyl radical; a halogen atom; a C₁₋₈ alkoxy radical; a C₆₋₁₀ aryl or aryloxy radical; an amido radical which is unsubstituted or substituted by up to two C₁₋₈ alkyl radicals; a phosphido radical which is unsubstituted or substituted by up to two C₁₋₈ alkyl radicals; silyl radicals of the formula —Si—(R)₃ wherein each R is independently selected from the group consisting of hydrogen, a C₁₋₈ alkyl or alkoxy radical, and C₆₋₁₀ aryl or aryloxy radicals; and germanyl radicals of the formula Ge—(R)₃ wherein R is as defined above.

36. The method according to claim 35, wherein the cyclopentadienyl-type ligand is selected from the group consisting of a cyclopentadienyl radical, an indenyl radical and a fluorenyl radical which radicals are unsubstituted or up to fully substituted by one or more substituents selected from the group consisting of a fluorine atom, a chlorine atom; C₁₋₄ alkyl radicals; and a phenyl or benzyl radical which is unsubstituted or substituted by one or more fluorine atoms.

37. The method according to claim 36, wherein at least one L is a bulky heteroatom ligand.

38. The method according to claim 37, wherein the bulky heteroatom ligand is a phosphinimine ligand of the formula: 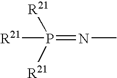
wherein each R₂₁ is independently selected from the group consisting of a hydrogen atom; a halogen atom; C₁₋₂₀, preferably C₁₋₁₀ hydrocarbyl radicals which are unsubstituted by or further substituted by a halogen atom; a C₁₋₈ alkoxy radical; a C₆₋₁₀ aryl or aryloxy radical; an amido radical; a silyl radical of the formula:
—Si—(R²²)₃
wherein each R²² is independently selected from the group consisting of hydrogen, a C₁₋₈ alkyl or alkoxy radical, and C₆₋₁₀ aryl or aryloxy radicals; and a germanyl radical of the formula:
Ge—(R²²)₃
wherein R²² is as defined above.

39. The method according to claim 38, wherein in the phosphinimine ligand R²¹ is independently selected from the group consisting of C₁₋₆ hydrocarbyl radicals.

40. The method according to claim 39, wherein in the phosphinimine ligand each R²¹ is a t-butyl radical.

41. The method according to claim 37, wherein the bulky heteroatom ligand is a ketimide ligand of the formula: 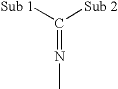
wherein “Sub 1” and “Sub 2” are independently selected from the croup consisting of C₁₋₆ alkyl radicals.
